(19) United States
(12) Patent Application Publication
(10) Pub. No.: US 2025/0018506 A1
(43) Pub. Date: Jan. 16, 2025

(54) METHOD AND DEVICE FOR CALIBRATING AN OPTICAL SYSTEM

(71) Applicant: Nikon SLM Solutions AG, Luebeck (DE)

(72) Inventors: Marco Standfuss, Luebeck (DE); Karsten Neumann, Luebeck (DE)

(21) Appl. No.: 18/699,915

(22) PCT Filed: Dec. 14, 2022
(86) PCT No.: PCT/EP2022/085755

§ 371 Date: Apr. 10, 2024

(30) Foreign Application Priority Data
Dec. 21, 2021 (DE) 10 2021 134 005.5

(51) Int. Cl. B23K 26/342; B22F 10/28; B22F 10/31; B22F 10/85; B22F 12/90; B23K 26/03; B23K 26/042; B28B 1/00; B28B 17/00; B29C 64/153; B29C 64/268; B29C 64/393; B33Y 10/00; B33Y 30/00; B33Y 50/02

(52) U.S. Cl. CPC B23K 26/342; B22F 10/31; B22F 10/85; B22F 12/90; B23K 26/032; B23K 26/042; B28B 1/001; B28B 17/0081; B29C 64/153; B29C 64/393; B33Y 50/02; B22F 10/28; B29C 64/268; B33Y 10/00; B33Y 30/00

(57) ABSTRACT

A method for calibrating an optical system (24), in particular for use in an apparatus (100) for producing a three-dimensional work piece by irradiating layers of a raw material powder is described. The method comprises the step i) generating a calibration spot (C) by irradiating a target (32) with a radiation beam (14) emitted by an optical unit (16) at a known position within a scanner coordinate system of a scanner (22) configured to scan the radiation beam (14) across an irradiation plane (I). In a step ii), a calibration beam (36) is emitted from the calibration spot (C) in a direction of the optical system (24) to be calibrated. In a step iii), the optical system (24) is calibrated such that a beam path of the calibration beam (36) emitted from the calibration spot (C) is collinear with a beam path of the radiation beam (14) used in step i) for generating the calibration spot (C).

The present invention relates to a method and a device for calibrating an optical system, in particular for use in an apparatus for producing a three-dimensional work piece by irradiating layers of a raw material powder with a radiation beam.

Powder bed fusion is an additive manufacturing process by which pulverulent, in particular metallic and/or ceramic raw materials can be processed to three-dimensional work pieces of complex shapes. To that end, a raw material powder layer is applied onto a carrier and subjected to electromagnetic or particle radiation in a site selective manner in dependence on the desired geometry of the work piece that is to be produced. The radiation penetrating into the powder layer causes heating and consequently melting or sintering of the raw material powder particles. Further raw material powder layers are then applied successively to the layer on the carrier that has already been subjected to laser treatment, until the work piece has the desired shape and size. Powder bed fusion can be used in particular to produce prototypes, tools, replacement parts or medical prostheses, such as, for example, dental or orthopedic prostheses, on the basis of CAD data.

For monitoring the irradiation process and in particular the melting and sintering conditions at the irradiation spot, at which the radiation beam is incident on the raw material powder layer and generates a melt pool, a melt pool monitoring system may be employed. The melt pool monitoring system may, for example, comprise a camera and/or a pyrometric detecting unit which is equipped with an optical detector sensitive for radiation in a wavelength region corresponding to the thermal radiation emitted at the irradiation spot. The melt pool monitoring system thus outputs images and/or sensor values that are, for example, indicative of the size and the shape of the melt pool and/or the temperature of the melt pool. The measurement data collected by the melt pool monitoring system may be used for quality control purposes either during the irradiation process or after completion of a build process for generating a three-dimensional work piece.

A method and a device for calibrating a pyrometric detecting device which is equipped with a pyrometric detecting unit configured to receive thermal radiation emitted at different points of a detection plane is described in EP 3 023 747 B1. This known method involves the use of a plate shaped substrate, a plurality of light guides and a light source. Light emitted by the light source is coupled into first ends of the light guides. Second ends of the light guides are fixed to the substrate, for example so as to define a matrix arrangement and so as to emit light in a main light emission direction that corresponds to a light detection direction of the pyrometric detecting unit.

For calibrating the pyrometric detecting unit, the substrate is positioned such that the second ends of the light guides are arranged in a detection plane of the pyrometric detecting unit. A light directing unit of the pyrometric detecting unit is controlled such that at a predetermined time, the light emitted from one predetermined light guide arranged at a predetermined position in the detection plane is detected by the pyrometric detecting unit. Due to angle and/or location dependencies, light intensity values measured by the pyrometric detecting unit may differ even though the light intensity emitted from each one of the plurality of light guides is substantially the same. By comparing the different measured values, the pyrometric detecting device may be calibrated and angle and/or location dependencies may be compensated.

The invention is directed at the object to provide a method and a device which allows a simple and reliable calibration of an optical system which is in particular suitable for use in an apparatus for producing a three-dimensional work piece by irradiating layers of a raw material powder with a radiation beam.

The invention is set out in the independent claims. Preferred embodiments of the invention are outlined in the dependent claims.

The present disclosure concerns a method for calibrating an optical system which is in particular suitable for use in an apparatus for producing a three-dimensional work piece by irradiating layers of a raw material powder. The method comprises a step i) of generating a calibration spot by irradiating a target with a radiation beam emitted by an optical unit at a known position within a scanner coordinate system of a scanner configured to scan the radiation beam across an irradiation plane. The radiation beam which is used for generating the calibration spot may be a beam of electromagnetic radiation or particle radiation.

An irradiation system of the apparatus for producing a three-dimensional work piece may comprise only a single optical unit such that the irradiation system is designed in the form of a single beam irradiation system generating only a single radiation beam. It is, however, also conceivable that the irradiation system is designed in the form of a multi beam irradiation system which comprises a plurality of optical units and which hence is configured to generate a plurality of radiation beams. In the latter case, the calibration spot may be generated by a selected one of the radiation beams emitted by a selected one of the optical units of the irradiation system. The irradiation system may further comprise a radiation source, in particular a laser source, for example a diode pumped Ytterbium fiber laser. The irradiation system may be provided with only one radiation source. In particular in case the irradiation system is designed in the form of a multi beam irradiation system, it is, however, also conceivable that the irradiation system is equipped with a plurality of radiation sources.

The scanner which is used to scan the radiation beam across the irradiation beam may be a component of the irradiation system. The scanner may comprise a pivotable scanner mirror which is adapted to scan the radiation beam across the irradiation plane. Besides the scanner, the irradiation system may further comprise a beam expander for expanding a radiation beam emitted by the radiation source and an object lens, in particular a f-theta object lens. Alternatively, the irradiation system may comprise a beam expander including a focusing optic.

The term “scanner coordinate system” within the context of this application defines a coordinate system which serves to establish a correlation between a scanner set up, in particular an angular position of a scanner mirror, and an irradiation spot, i.e. a point of incidence of the radiation beam in the irradiation plane. Typically, the scanner coordinate system does not coincide with a global machine coordinate system of, e.g., the apparatus for producing a three-dimensional work piece. For the purpose of the calibration method described herein, it is, however, sufficient to define the location of the calibration spot within the irradiation plane by reference to the scanner coordinate system, i.e. it is not required to localize the calibration spot in the global machine coordinate system.

In a step ii) of the method for calibrating an optical system, a calibration beam is emitted from the calibration spot in a direction of the optical system to be calibrated. Preferably, the radiation beam which is used for generating the calibration spot and the calibration beam are not emitted simultaneously. Specifically, steps I) and II) may be executed one after another. Step I) may be executed first so as to generate the calibration spot and only thereafter, i.e. after completion of step I, step II) may be executed. In particular, the calibration beam emitted from the calibration spot is directed to the optical system via the scanner which is used to direct the radiation beam to the calibration spot in step i). For example, a scanner mirror may be maintained in the same angular position for generating of the calibration spot by irradiating the target with the radiation beam in step i) and for directing the calibration beam emitted from the calibration spot to the optical system to be calibrated in step ii).

In a step iii) the optical system is calibrated such that a beam path of the calibration beam emitted from the calibration spot is collinear with a beam path of the radiation beam used in step i) for generating the calibration spot. For calibrating the optical system, at least one optical component of the optical system, for example an optical mirror, may be adjusted by means of a suitable adjustment device, e.g. a manually or automatically operable actuator, such that an optical center of the optical system is aligned with the calibration spot.

The method for calibrating an optical system described herein is suitable for calibrating all optical systems which, with respect to the beam path of the radiation beam, are designed in the form of an inline system, i.e. which emit or receive radiation following the same beam path as the radiation beam. In the method, an accurate positioning of a calibration beam emission device within the machine coordinate system can be dispensed with. Further, the method is independent from the accuracy of a scan field correction of the optical system to be calibrated and a previously used calibration plate. Consequently, the method allows a reliable calibration of the optical system within a short time more or less independent of the skills of a human operator. The alignment of the optical system may be performed either manually or with the aid of a software which is executed on a control unit and which controls corresponding actuators of the optical system.

In step i), the target may be positioned in the irradiation plane in a region which is expected to encompass the known position within the scanner coordinate system of the scanner. The irradiation plane irradiated by the radiation beam in the calibration method described herein may coincide with an irradiation plane onto which the radiation beam is incident during normal operation of the apparatus for producing a three-dimensional work piece. For example, the irradiation plane irradiated by the radiation beam in the calibration method may coincide with an irradiation plane which is defined by a surface of the raw material powder layers which are selectively irradiated during operation of the apparatus for producing the three-dimensional work piece. The region for positioning the target may be selected while considering typical positional deviations or tolerances occurring upon scanning the radiation beam across the irradiation plane. It is, however, also conceivable to use a target which is sized and dimension so as to cover the entire surface area of the irradiation plane.

The calibration spot generated in step i) may be a visible spot on the target, onto which the calibration beam emission device may be placed before emitting the calibration beam in the direction of the optical system to be calibrated. Alternatively, the calibration spot generated in step i) may be defined by a pinhole generated by irradiating the target with the radiation beam. The calibration beam emission device then may already be arranged in place during generation of the calibration spot. The pinhole generated by irradiating the target with the radiation beam may be a through hole extending through the target. It is, however, also conceivable that the irradiation of the target with the radiation beam merely generates a calibration spot which transmits light emitted by the calibration beam emission device.

The calibration spot may, however, also assume another form or may be generated in a different manner. For example, the calibration spot may also be defined by a beam reflecting and/or beam scattering structure generated in the target by irradiating the target with the radiation beam.

The target may be a film, in particular an aluminum film or a transparent film, which may be arranged in the irradiation plane. For example, the target may be fixed to suitable clamping device so as to extend across at least a region of the irradiation plane.

The calibration beam may be generated by a light source or may be reflected and/or scattered from the calibration spot.

In particular in case the calibration beam emission device comprises a light source for generating the calibration beam, the target preferably is arranged in the beam path of the calibration beam generated by the light source between the light source and the optical system to be calibrated.

Further, in a preferred embodiment of the method for calibrating an optical system, a shutter may be arranged in the beam path of the radiation beam between the target and the light source at least during generating the calibration spot in step i). The placement of a shutter between the target and the light source serves to protect the light source from an interaction with a radiation beam upon generating the calibration spot. The shutter may, however, also be omitted, e.g. in case the light source is designed so as to be insensitive to the radiation beam or in case the light source is placed in the beam path of the radiation beam only after the generation of the pinhole. A shutter is also not required in case the calibration beam is a beam which is reflected and/or scattered by a beam reflecting or beam scattering structure generated in the target.

As already indicated above, the optical system to be calibrated preferably is a system which, with respect to the beam path of the radiation beam, is designed in the form of an inline system which emits or receives radiation following the same beam path as the radiation beam. For example, the optical system may comprise an optical sensor system of a melt pool monitoring system, a camera based system, a photodiode based system and/or an optical coherence tomography system.

The method of the present disclosure may further comprise a step iv) of generating a further calibration spot by irradiating the target with a further radiation beam emitted by a further optical unit at a known position within a further scanner coordinate system of a further scanner configured to scan the further radiation beam across the irradiation plane.

A further calibration beam may be emitted from the further calibration spot in a direction of a further optical system to be calibrated. The further optical system to be calibrated may be associated with the further optical unit which generates the further radiation beam. The further optical system may be calibrated such that a beam path of the further calibration beam emitted from the further calibration spot is collinear with a beam path of the further radiation beam used in step iv) for generating the further calibration spot. Thus, the further optical system may be calibrated in a similar manner as the optical system.

Alternatively or additionally it is, however, also conceivable to emit a further calibration beam from the further calibration spot in a direction of the optical system. The scanner coordinate system of the scanner and/or the further scanner coordinate system of the further scanner may then be adjusted so as to coincide. The calibration method thus may also be used for collinearly aligning a plurality of optical units.

The present disclosure also relates to a device for calibrating an optical system, in particular for use in an apparatus for producing a three-dimensional work piece by irradiating layers of a raw material powder. The device comprises a target configured to be irradiated with a radiation beam emitted by an optical unit at a known position within a scanner coordinate system of a scanner configured to scan the radiation beam across an irradiation plane so as to generate a calibration spot. The device further comprises a calibration beam emission device configured to generate a calibration beam emitted from the calibration spot. Moreover, the device comprises an adjustment device configured to allow a calibration of the optical system such that a beam path of the calibration beam emitted from the calibration spot is collinear with a beam path of the radiation beam used for generating the calibration spot. The adjustment device may, for example, comprise a manually or automatically operable actuator such that either a manual or an automatic calibration of the optical system is made possible.

A control unit may be provided in the device for calibrating an optical system which is configured to control the optical unit and the calibration beam emission device such that the radiation beam which is used for generating the calibration spot and the calibration beam are not emitted simultaneously. The control unit may be configured to automatically or manually control the emission of the radiation beam and the calibration beam. Specifically, the control unit may be configured to control the optical unit and the calibration beam emission device such that the radiation beam which is used for generating the calibration spot is emitted first and the calibration beam is emitted only after the emission of the radiation beam is terminated.

The device may further comprise a positioning device configured to position the target in the irradiation plane in a region which is expected to encompass the known position within the scanner coordinate system of the scanner.

The calibration spot may be defined by a pinhole generated by irradiating the target with the radiation beam. Alternatively, the calibration spot may be defined by a beam reflecting or beam scattering structure generated in the target by irradiating the target with the radiation beam.

The target may be a film, in particular an aluminum film or a transparent film, which is configured to be is arranged in the irradiation plane.

The calibration beam emission device may comprise a light source or the beam reflecting or beam scattering structure generated in the target by irradiating the target with the radiation beam.

The target may be arranged in the beam path of the calibration beam generated by the light source between the light source and the optical system to be calibrated.

The device may further comprise a shutter configured to be arranged in the beam path of the radiation beam between the target and the light source at least during generating the calibration spot.

The optical system to be calibrated may comprise an optical sensor system, in particular an optical sensor system of a melt pool monitoring system, a camera based system, a photodiode based system and/or an optical coherence tomography system. The optical system may also comprise further components such as (a) shutter(s), (a) lens(es) and/or (a) mirror(s).

The device may comprise a further optical unit configured to irradiate the target with a further radiation beam at a known position within a further scanner coordinate system of a further scanner configured to scan the further radiation beam across the irradiation plane so as to generate a further calibration spot.

The calibration beam emission device may be configured to emit a further calibration beam from the further calibration spot in a direction of a further optical system to be calibrated. Further, the device may comprise a further adjustment device configured to allow a calibration of the further optical system such that a beam path of the further calibration beam emitted from the further calibration spot is collinear with a beam path of the further radiation beam used for generating the further calibration spot.

Alternatively or additionally, the calibration beam emission device may be configured to emit a further calibration beam from the further calibration spot in a direction of the optical system. The adjustment device and/or the further adjustment device may be configured to adjust the scanner coordinate system of the scanner and/or the further scanner coordinate system of the further scanner so as to coincide.

Preferred embodiments of the invention will be described in greater detail with reference to the appended schematic drawings wherein

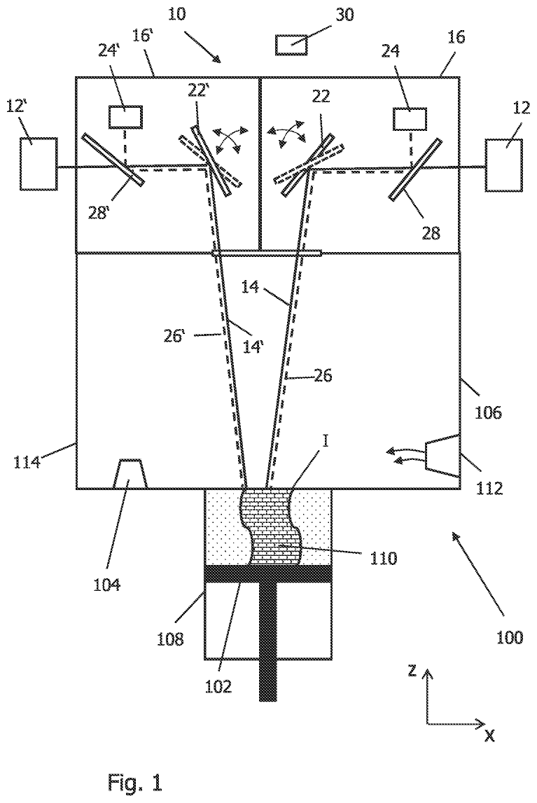

FIG. 1 shows an apparatus for producing a three-dimensional work piece by irradiating layers of a raw material powder with a radiation beam;

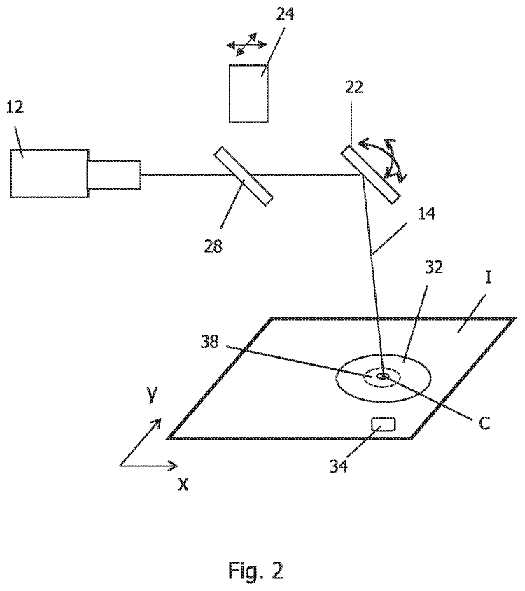

FIG. 2 shows a step of generating a calibration spot in a method for calibrating an optical system employed in the apparatus depicted in FIG. 1;

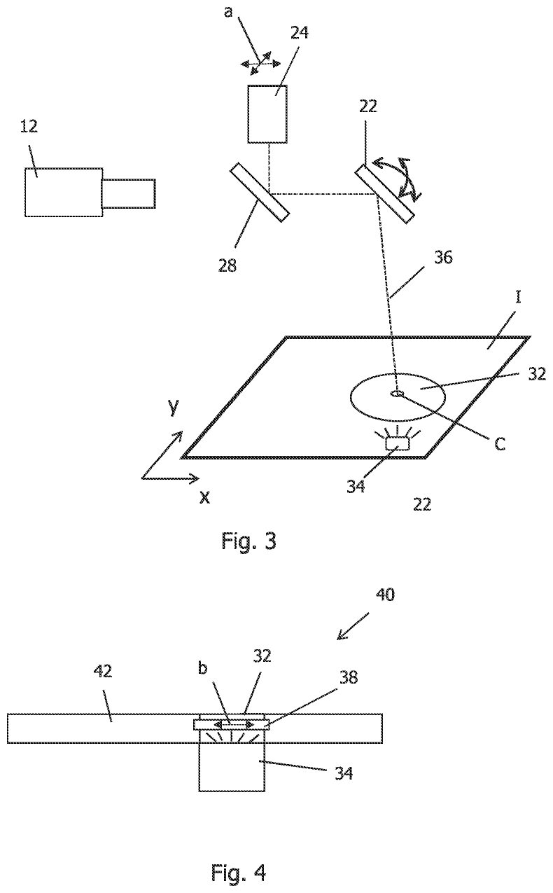

FIG. 3 shows a step of emitting a calibration beam generated by a light source from the calibration spot in the direction of the optical system to be calibrated; and

FIG. 4 shows a schematic illustration of a device for calibrating an optical system as illustrated in FIGS. 2 and 3.

FIG. 1 shows an apparatus 100 for producing a three-dimensional work piece by an additive manufacturing process. The apparatus 100 comprises a carrier 102 and a powder application device 104 for applying a raw material powder onto the carrier 102. The raw material powder may be a metallic powder, but may also be a ceramic powder or a plastic material powder or a powder containing different materials. The powder may have any suitable particle size or particle size distribution. It is, however, preferable to process powders of particle sizes <100 μm. The carrier 102 and the powder application device 104 are accommodated within a process chamber 106 which is sealable against the ambient atmosphere. The carrier 102 is displaceable in a vertical direction into a built cylinder 108 so that the carrier 102 can be moved downwards with increasing construction height of a work piece 110, as it is built up in layers from the raw material powder on the carrier 12. The carrier 102 may comprise a heater and/or a cooler.

The apparatus 100 further comprises an irradiation system 10 for selectively irradiating laser radiation onto a raw material powder layer applied onto the carrier 102. In the embodiment of an apparatus 100 shown in FIG. 1, the irradiation system 10 comprises a radiation beam source 12 which is configured to generate a radiation beam 14 and a further radiation beam source 12′ configured to generate a further radiation beam 14′. The radiation beam sources 12, 12′ may be laser beam sources which are configured to generate a laser beam. An optical unit 16 for guiding and processing the radiation beam 14 generated by the radiation beam source 12 is associated with the radiation beam source 12. A further optical unit 16′ for guiding and processing the further radiation beam 14′ generated by the further radiation beam source 12′ is associated with a further radiation beam source 12′. It is, however, also conceivable the optical unit 16 and the further optical unit 16′ are associated with a single radiation beam source and/or that the irradiation system 10 comprises a plurality of optical units and hence is configured to generate more than two radiation beams.

Each of the optical units 16, 16′ may comprise two lenses (not shown) which both have positive refractive power. One lens may be configured to collimate the laser light emitted by the radiation beam source 12, 12′, such that a collimated or substantially collimated radiation beam is generated. A further lens may be configured to focus the collimated (or substantially collimated) radiation beam 14, 14′ on a desired position in a z-direction. Each of the optical units 16 further comprises a pivotable scanner mirror 22, 22′ which serves to deflect the radiation beam 14, 14′ and hence scan the radiation beam 14, 14′ in a x-direction and a y-direction across an irradiation plane I which, during operation of the apparatus 100 typically is defined by a surface of a raw material powder layer applied onto the carrier 102 so as to be selectively irradiated.

Optical systems 24, 24′ which in the embodiment shown in FIG. 1 are designed in the form of optical sensor systems form a part of a melt pool monitoring system and hence serve to observe the melt pool which is generated when the radiation beam 14, 14′ impinges onto the raw material powder. Specifically, each of the optical systems 24, 24′ outputs sensor values that are melt pool temperature related or indicative of the temperature of the melt pool.

Each of the optical systems 24, 24′ is designed in the form of an inline system which receives thermal radiation 26, 26′ following the same beam path as the radiation beam 14, 14′. For this purpose, each of the optical units 16, 16′ comprises a semitransparent beam splitter 28, 28′ which is suitable to transmit the radiation beam 14, 14′ emitted by the radiation source 12, 12′ but to deflect the thermal radiation beam 26, 26′ emitted from the melt pool. Thus, the thermal radiation beam 26, 26′ emitted from the melt pool, after being deflected by the scanner mirror 22, 22′ is finally directed to the optical system 24, 24′ by the beam splitter 28, 28′.

A control unit 30 is provided for controlling either exclusively the operation of the optical systems 24, 24′ or also for controlling further components of the apparatus 100 such as, for example, the irradiation system 10 and/or the powder application device 104.

A controlled gas atmosphere, preferably an inert gas atmosphere is established within the process chamber 106 by supplying a shielding gas to the process chamber 106 via a process gas inlet 112. After being directed through the process chamber 106 and across the raw material powder layer applied onto the carrier 102, the gas is discharged from the process chamber 106 via a process gas outlet 114. The process gas may be recirculated from the process gas outlet 114 to the process gas inlet 112 and thereupon may be cooled or heated.

During operation of the apparatus 100 for producing a three-dimensional work piece, a layer of raw material powder is applied onto the carrier 102 by means of the powder application device 104. In order to apply the raw material powder layer, the powder application device 104 is moved across the carrier 102, e.g. under the control of the control unit 30. Then, e.g. again under the control of the control unit 30, the layer of raw material powder is selectively irradiated in accordance with a geometry of a corresponding layer of the work piece 110 to be produced by means of the irradiation device 10. The steps of applying a layer of raw material powder onto the carrier 102 and selectively irradiating the layer of raw material powder in accordance with a geometry of a corresponding layer of the work piece 110 to be produced are repeated until the work piece 110 has reached the desired shape and size.

A method for calibrating the optical system 24 in order to allow an accurate detection of the radiation/temperature of the melt pool independent of the position of the melt pool within the irradiation plane I now is described with reference to FIGS. 2 and 3.

As shown in FIG. 2, a target 32 is positioned in the irradiation plane I. In the embodiment shown in the drawings, the target 32 is designed in the form of a thin film, in particular an aluminium film. In a step i) of the method for calibrating the optical system 24, a calibration spot C is generated by irradiating the target 32 with the radiation beam 14 emitted by the irradiation system 10 of the apparatus 100 at a known position within a scanner coordinate system of the scanner 22 which scans the radiation beam 14 across the irradiation plane I. Thus, the position of the calibration spot C within the x-y irradiation plane I might not be known exactly in terms of x-y coordinates within a machine coordinate system, but is still identifiable by its scanner coordinates. However, the target 32 is positioned in a region of the irradiation plane I which is expected to encompass the known position within the scanner coordinate system of the scanner 22. Specifically, the radiation beam 14 incident on the target 32 generates a calibration spot C in the form of a pinhole which extends through the target 32.

A calibration beam emission device designed in the form of a light source 34 which is capable of generating a calibration beam 36 is arranged below the target 32. Specifically, the light source 34 is arranged at such a position relative to calibration spot C that the calibration beam 36 generated by light source 34, in a step ii) of the method for calibrating the optical system 24 is emitted from the calibration spot C and directed to the optical system 24 via the scanner mirror 22 which is used to direct the radiation beam 14 to the calibration spot C in step i) and the semitransparent beam splitter 28, see FIG. 3. Steps I) and II) are executed one after another, i.e. the calibration beam 36 is emitted from the calibration spot C only after the emission of the radiation beam 14 is stopped after the generation of the calibration spot C is completed. The scanner mirror 22 is maintained in the same angular position for generating of the calibration spot C by irradiating the target 32 with the radiation beam 14 in step i) and for directing the calibration beam 36 emitted from the calibration spot C to the optical system 24 to be calibrated in step ii).

In a step iii) of the method for calibrating the optical system 24, the optical system 24 is calibrated such that a beam path of the calibration beam 36 emitted from the calibration spot C is collinear with a beam path of the radiation beam 14 used in step i) for generating the calibration spot C. For example, the optical system 24 may be calibrated by adjusting an optical mirror of the optical system 24 under the control of the control unit 30, such that an optical center of the optical system 24 is aligned with the calibration spot C as indicated by the arrows a in FIG. 3. It is, however, also conceivable that the calibration of the optical system 24 involves an adjustment by moving or tilting a sensor of the optical system 24, a twisting of a plane plate (beam offset) or other suitable adjustment procedures.

In the embodiment shown in the drawings, the target 32 is arranged in the beam path of the calibration beam 36 generated by the light source 34 between the light source 34 and the optical system 24 to be calibrated. Further, the target 32 is arranged in the beam path of the radiation beam 14 between the radiation source 12 and the light source 34. In order to protect the light source 34 from damages that may caused by the radiation beam 14 upon generating the pinhole, a shutter 38 is arranged in the beam path of the radiation beam 14 between the target 32 and the light source 34 at least during calibrating the calibration spot C in step i). In step ii), the shutter 38, however, is removed in order to allow an unhindered propagation of the calibration beam 36 through the pinhole generated within the target 32.

The shutter 38 may, however, also be omitted, e.g. in case the light source 34 is designed so as to be insensitive to the radiation beam 14 or in case the light source 34 is placed in the beam path of the radiation beam 14 only after the generation of the pinhole. The shutter 38 is also not required in case the calibration beam 36 is a beam which is not generated by a light source 34, but instead reflected and/or scattered by a calibration beam emission device designed in the form of a a beam reflecting or beam scattering structure generated in the target in step i).

The further optical system 24′ may be calibrated in the same manner as the optical system 24. In particular, in a step iv), a further calibration spot may be generated by irradiating the target 32 with the further radiation beam 14′ emitted by the further optical unit 16′ at a known position within a further scanner coordinate system of the further scanner 22′ configured to scan the further radiation beam 14′ across the irradiation plane I. A further calibration beam may be emitted from the further calibration spot in a direction of a further optical system 24′ to be calibrated.

The further optical system 24′ may then be calibrated such that a beam path of the further calibration beam emitted from the further calibration spot is collinear with a beam path of the further radiation beam 14′ used in step iv) for generating the further calibration spot. Like the optical system 24, also the further optical system 24′ may be calibrated by adjusting an optical mirror of the further optical system 24 under the control of the control unit 30, such that an optical center of the further optical system 24′ is aligned with the further calibration spot. It is, however, again also conceivable that the calibration of the further optical system 24′ involves an adjustment by moving or tilting a sensor of the further optical system 24′, a twisting of a plane plate (beam offset) or other suitable adjustment procedures which may be performed manually with the a.

Moreover, a further calibration beam may be emitted from the further calibration spot in a direction of the optical system 24. The scanner coordinate system of the scanner 22 and/or the further scanner coordinate system of the further scanner 22′ may then be adjusted so as to coincide. Thus, the optical units 16, 16′ may be used collinearly aligned.

Thus, the calibration method may also be used for collinearly aligning a plurality of optical units.

A device 40 for calibrating the optical systems 24, 24′ as shown in FIGS. 2 and 3 and described above is schematically illustrated in FIG. 4. The device 40 comprises a positioning device 42 for positioning and appropriately attaching the target 32 at a desired position within the irradiation plane I. The light source 34 is attached to the positioning device 42 so as to be positioned below the target 32. The shutter 38 is movably accommodated in the positioning device 42. In particular, the shutter is displaceable relative to the positioning device 42, the light source 34 and the target 32 as indicated by the arrow b in FIG. 4.

The device 40 may comprise further components such as, for example, a filter arrangement (not shown) which makes it possible to arrange different optical filters in the beam of the calibration beam 36 emitted from the calibration spot C. The optical filters may change the intensity of the calibration beam 36 emitted from the calibration spot C and thus may be used for calibrating a radiation intensity detection function of the optical unit 24. Further, the device 40 may be used for adjusting a focal spot of the optical unit 24, for example in such a manner that substantially only the calibration beam 36 emitted from the calibration spot C is directed to the optical unit 24.

1-18. (canceled)

19. A method for calibrating an optical system for use in an apparatus for producing a three-dimensional work piece by irradiating layers of a raw material powder, the method comprising the steps of:
i) generating a calibration spot by irradiating a target with a radiation beam emitted by an optical unit at a known position within a scanner coordinate system of a scanner configured to scan the radiation beam across an irradiation plane;
ii) emitting a calibration beam from the calibration spot in a direction of the optical system to be calibrated; and
iii) calibrating the optical system such that a beam path of the calibration beam emitted from the calibration spot is collinear with a beam path of the radiation beam used in step i) for generating the calibration spot.

20. The method according to claim 19,
wherein in step i), the target is positioned in the irradiation plane in a region which is expected to encompass the known position within the scanner coordinate system of the scanner.

21. The method according to claim 19,
wherein the calibration spot generated in step i) is defined by a pinhole generated by irradiating the target with the radiation beam or by a beam reflecting and/or beam scattering structure generated in the target by irradiating the target with the radiation beam.

22. The method according to claim 19,
wherein:
the target is a film, in particular an aluminum film or a transparent film, which is arranged in the irradiation plane; and/or
the calibration beam is generated by a light source or is reflected and/or scattered from the calibration spot.

23. The method according to claim 22,
wherein:
the target is arranged in the beam path of the calibration beam generated by the light source between the light source and the optical system to be calibrated; and/or
a shutter is arranged in the beam path of the radiation beam between the target and the light source at least during generating the calibration spot in step i).

24. The method according to claim 19,
wherein the optical system comprises an optical sensor system, in particular an optical sensor system of a melt pool monitoring system, a camera based system, a photodiode based system and/or an optical coherence tomography system.

25. The method according to claim 19,
further comprising
iv) generating a further calibration spot by irradiating the target with a further radiation beam emitted by a further optical unit at a known position within a further scanner coordinate system of a further scanner configured to scan the further radiation beam across the irradiation plane.

26. The method according to claim 25,
further comprising
v) emitting a further calibration beam from the further calibration spot in a direction of a further optical system to be calibrated; and
vi) calibrating the further optical system such that a beam path of the further calibration beam emitted from the further calibration spot is collinear with a beam path of the further radiation beam used in step iv) for generating the further calibration spot.

27. The method according to claim 25,
further comprising
v) emitting a further calibration beam from the further calibration spot in a direction of the optical system; and
vi) adjusting the scanner coordinate system of the scanner and/or the further scanner coordinate system of the further scanner so as to coincide.

28. A device for calibrating an optical system for use in an apparatus for producing a three-dimensional work piece by irradiating layers of a raw material powder, the device comprising:
i) a target configured to be irradiated with a radiation beam emitted by an optical unit at a known position within a scanner coordinate system of a scanner configured to scan the radiation beam across an irradiation plane so as to generate a calibration spot;
ii) a calibration beam emission device configured to emit a calibration beam from the calibration spot in a direction of the optical system to be calibrated; and
iii) an adjustment device configured to allow a calibration of the optical system such that a beam path of the calibration beam emitted from the calibration spot is collinear with a beam path of the radiation beam used for generating the calibration spot.

29. The device according to claim 28,
further comprising a positioning device configured to position the target in the irradiation plane in a region which is expected to encompass the known position within the scanner coordinate system of the scanner.

30. The device according to claim 28,
wherein the calibration spot is defined by a pinhole generated by irradiating the target with the radiation beam or by a beam reflecting and/or beam scattering structure generated in the target by irradiating the target with the radiation beam.

31. The device according to claim 28,
wherein:
the target is a film, in particular an aluminum film or a transparent film, which is configured to be arranged in the irradiation plane; and/or
the calibration beam emission device comprises a light source or the beam reflecting and/or beam scattering structure generated in the target by irradiating the target with the radiation beam.

32. The device according to claim 31,
wherein:
the target is arranged in the beam path of the calibration beam generated by the light source between the light source and the optical system to be calibrated; and/or
the device further comprises a shutter configured to be arranged in the beam path of the radiation beam between the target and the light source at least during generating the calibration spot.

33. The device according to claim 28,
wherein the optical system comprises an optical sensor system, in particular an optical sensor system of a melt pool monitoring system, a camera based system, a photodiode based system and/or an optical coherence tomography system.

34. The device according to claim 28,
further comprising
iv) a further optical unit configured to irradiate the target with a further radiation beam at a known position within a further scanner coordinate system of a further scanner configured to scan the further radiation beam across the irradiation plane so as to generate a further calibration spot.

35. The device according to claim 34,
wherein
v) the calibration beam emission device is configured to emit a further calibration beam from the further calibration spot in a direction of a further optical system to be calibrated; and
wherein the device further comprises
vi) a further adjustment device configured to allow a calibration of the further optical system such that a beam path of the further calibration beam emitted from the further calibration spot is collinear with a beam path of the further radiation beam used for generating the further calibration spot.

36. The device according to claim 34,
wherein
v) the calibration beam emission device is configured to emit a further calibration beam from the further calibration spot in a direction of the optical system; and
vi) the adjustment device is configured to adjust the scanner coordinate system of the scanner and/or the further scanner coordinate system of the further scanner so as to coincide. Amendments to the Specification: On page 1 of the specification, please insert the following immediately after the title: CROSS-REFERENCES TO RELATED APPLICATIONS This application is the U.S. national phase application of international patent application PCT/EP 2022/085755 filed on Dec. 14, 2022 and claims the benefit of German patent application No. 10 2021 134 005.5 filed on Dec. 21, 2021, the entire disclosures of which are incorporated herein by way of reference.
